(19) United States
(12) Patent Application Publication
(10) Pub. No.: US 2003/0137849 A1
(43) Pub. Date: Jul. 24, 2003

(54) Segmented distribution headlight system, method, and apparatus

(76) Inventor: Ray M. Alden, Raleigh, NC (US)

Correspondence Address: Ray M. Alden, 808 Lake Brandon Trail, Raleigh, NC, 27610, US

(21) Appl. No.: 10/054,223

(22) Filed: Jan. 22, 2002

(51) Int. Cl. F21V 14/00; B60Q 1/14; B60Q 1/08

(52) U.S. Cl. 362/466; 362/513; 362/276; 315/82; 315/154

(57) ABSTRACT

The invention described herein represents a significant improvement in the art of headlights for vehicles. A first element is provided as a means for sensing the presence and location of other motor vehicles, said means for sensing connected to processing and light controlling circuitry such that the electrical current supplied to each element in an array of elements is individually controlled. The result is a headlight system which produces high beams in areas where no vehicle is present and concurrently produces low beams in areas where vehicles are present. In a first embodiment, individual light elements in array are individually controlled with regard to intensity to provide dim beam areas and high beam areas concurrently. In a second embodiment, individual electro-chromatic elements in array are individually controlled so as to provide a means to create dim beam areas and high beam areas concurrently. In a third embodiment, variable refractive segments in array are individually controlled to redirect beam portions such that high beam and dim beam areas are created concurrently. All embodiments maximize the areas receiving high beams for the benefit of the equipped vehicle driver while concurrently all areas with other drivers present receive low beams so as to minimize the glare for to betterment of other drivers.

### BACKGROUND FIELD OF INVENTION

Over the past one hundred years, electric lighting has been implemented using many well know techniques to provide illumination in many applications. Well known electrical illumination techniques include incandescent, gas, and LED to name a few. In more recent decades, the prior art has incorporated sensors to control the on or off condition of a light source to provide illumination only when desired and to discontinue (or alternately dim) illumination when desired. Specifically, implementation of variable distribution vehicle headlights has been described in the prior art wherein a first vehicle includes a means to sense the presence or intensity of oncoming vehicle headlights of a second vehicle so as to automate the process of switching headlights of the first vehicle between a state of high beam and low beam.

The present invention provides a significant advancement in variable distribution headlights by providing a means to automatically dim some portions of the headlight distribution pattern while concurrently keeping other portions of the headlight distribution pattern illuminated on high beam. The result is an automated headlight system which enables the driver of a vehicle so equipped to see optimally while concurrently the driver of an oncoming (or alternately a leading) vehicle also can see optimally.

### DESCRIPTION OF PRIOR INVENTION

The prior art describes headlight illumination systems which automatically switch headlights between a high beam state and a low beam state. Said systems incorporating a first element to sense the presence of oncoming vehicles and a second element to send a corresponding signal to vary the intensity of headlights connected thereto and a third element for illumination (headlights which are varied according to sensed conditions). As an alternate to varying light intensity, the prior art teaches, providing a means to redirect headlights from a higher direction to a lower direction (and vice versa) or from a more central direction to a more rightward direction (and vice versa). The prior art methodology employed does enable automatic headlight interaction in response to environmental conditions in a way which provides some functionality to the driver of the equipped vehicle (enabling them to use the high beam as much as possible) and to the drivers of other vehicles passing within the light distribution (not being blinded by glare from the high beams) of the equipped vehicle. For example Stam et al (U.S. Pat. No. 6,281,632) provides an on vehicular means to accurately sense the environment and to accordingly change the headlight distribution of two entire headlights alternately between a first state (high beam) and a second state (low beam).

The prior art can easily be contrasted with the present invention when one considers that the prior art enables the headlight to be in only one state at a time while the present invention enables the headlight to be in a high beam state in parts of its distribution area while at the same time being in a low beam state in other parts of its distribution area. Thus the present invention enables the driver to see further ahead while at the same time not blinding other drivers due to high beam glare.

### BRIEF SUMMARY

The invention described herein represents a significant improvement for the safety of motor vehicles. Heretofore a tradeoff has existed between a driver benefiting from a high beam to see further ahead and that high beam costing the ability of other drivers' visibility (blinding them with glare). Thus the driver has to often use low beams to prevent blinding other drivers and in the process sacrificing his own ability to see ahead optimally. Often, this tradeoff creates a problem where either one, or the other, or both drivers' visibility is inhibited by excess glare or insufficient lighting. The problem is that headlights themselves have heretofore not been variable across their distribution area such that a single headlight shines a high beam in some portions of its distribution while concurrently shining a low beam in other portions of its distribution. Moreover, said headlight being automatically variable in response to sensed environmental conditions.

The present invention is a system for automatically controlling the distribution of a headlight in response to environmental conditions wherein, a means for sensing the locations of other vehicles is provided, said means dividing the exterior space into sectors and determining if an automobile is present in each respective sector. Additionally a headlight is provided which comprises a means for illuminating each said respective sector independently. Moreover automated control of the headlight intensity and or direction is provided at the sector level. The result is that the present headlight can stay on high beam in all sectors which do not contain a motor vehicle and concurrently go on low beam only in those sectors which do contain a motor vehicle. This maximizes the ability of all drivers to see at all times.

Thus the present invention offers a significant advancement in vehicular headlight systems.

### Objects and Advantages

Accordingly, several objects and advantages of the present invention are apparent. It is an object of the present invention to maximize the amount of light that the driver can use without inhibiting the ability of other drivers to see. It is an advantage of the present invention to provide a means for segmenting illumination into sectors of the light distribution area. It is an advantage of the present invention to independently control each illumination sector. It is an advantage of the present invention to automatically control each illumination sector in response to sensed environmental conditions. In a first embodiment, it is an advantage of the present invention to incorporate separate lighting elements within a head light, each of said elements corresponding to a sector of the light distribution area of the headlight, each of said elements being independently controllable as to intensity and/or direction. In a second embodiment, it is an advantage of the present invention to incorporate separate light dimming elements to interact with illumination from a headlight said dimming elements each interacting with a specific segment of the light distribution area and being independently controllable. In a third embodiment, it is an advantage of the present invention to incorporate separate light steering elements to interact with illumination from a headlight said steering elements each interacting with a specific segment of the light distribution area and being independently controllable.

Further objects and advantages will become apparent from the enclosed figures and specifications.

### DRAWING FIGURES

FIG. 1 depicts a vehicle employing an automatic segmented illumination means of the present invention.

FIG. 2 illustrates the elements of a segmented distribution illumination process.

FIG. 3 is a more detailed illustration of the information flow, processes and architecture of the elements described in FIG. 2.

FIG. 4 illustrates a flow chart describing logic flow of the processes described in FIG. 3.

FIG. 5 illustrates the segmented headlight means and controlling switch array in a first embodiment.

FIG. 6 illustrates headlight distribution area segmenting means of a second embodiment.

FIG. 7 is identical to FIG. 6 except that the alternate segmented electro-chromatic element 127a is incorporated into the optic (whereas they were separate components in FIG. 6).

FIG. 8 the element of an individual electro-optic cell in a first state.

FIG. 9 is an electro-optic material in a second state of alignment.

FIG. 10 depicts a segmented headlight with individually controlled sectors of distribution of the third embodiment.

FIG. 11 illustrates the art of the present invention being used to concentrate light to look around corners in response to road conditions.

FIG. 12 illustrates the art of the present invention being used to concentrate light to look up a hill in response to road conditions.

FIG. 13 illustrates the art of the present invention being used to concentrate light to look down a hill in response to road conditions.

FIG. 14 illustrates the segmented distribution light of the present invention integrated with the position of a steering wheel.

FIG. 15 is the steering wheel of FIG. 14 in a new position.

### DETAILED DESCRIPTION OF THE INVENTION

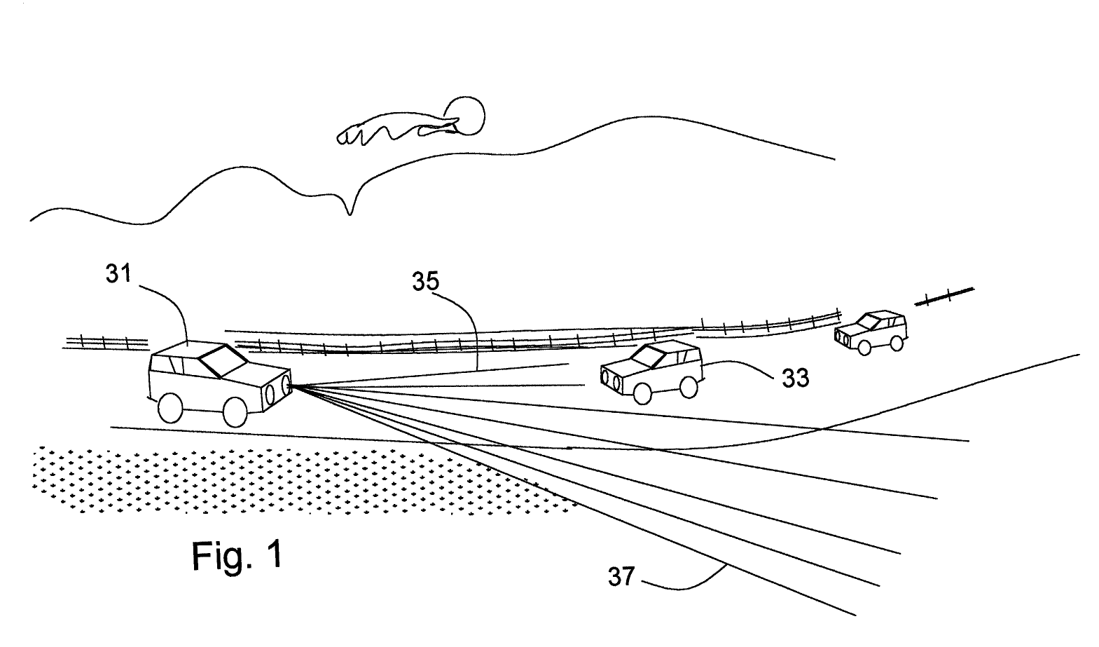

FIG. 1 depicts a vehicle employing an automatic segmented illumination means of the present invention. A first vehicle 31 emits a low beam illumination 35 in a first headlight distribution sector while concurrently emitting a high beam,illumination 37 in a second headlight distribution sector. The low beam illumination in 35 being emitted in response to the detection of an oncoming vehicle 33 (the 33 emitting light which has been omitted for drawing clarity). The 31 comprising a means to detect the sector in which 33 (or any other vehicle) is located, the 31 also comprising a means to provide a first intensity of illumination in the sector where the 33 is detected while concurrently providing a second intensity (or alternate direction) of illumination where no vehicle is detected. Specific means for sensing locations of vehicles and independent sector illumination control within the light distribution area will be discussed later.

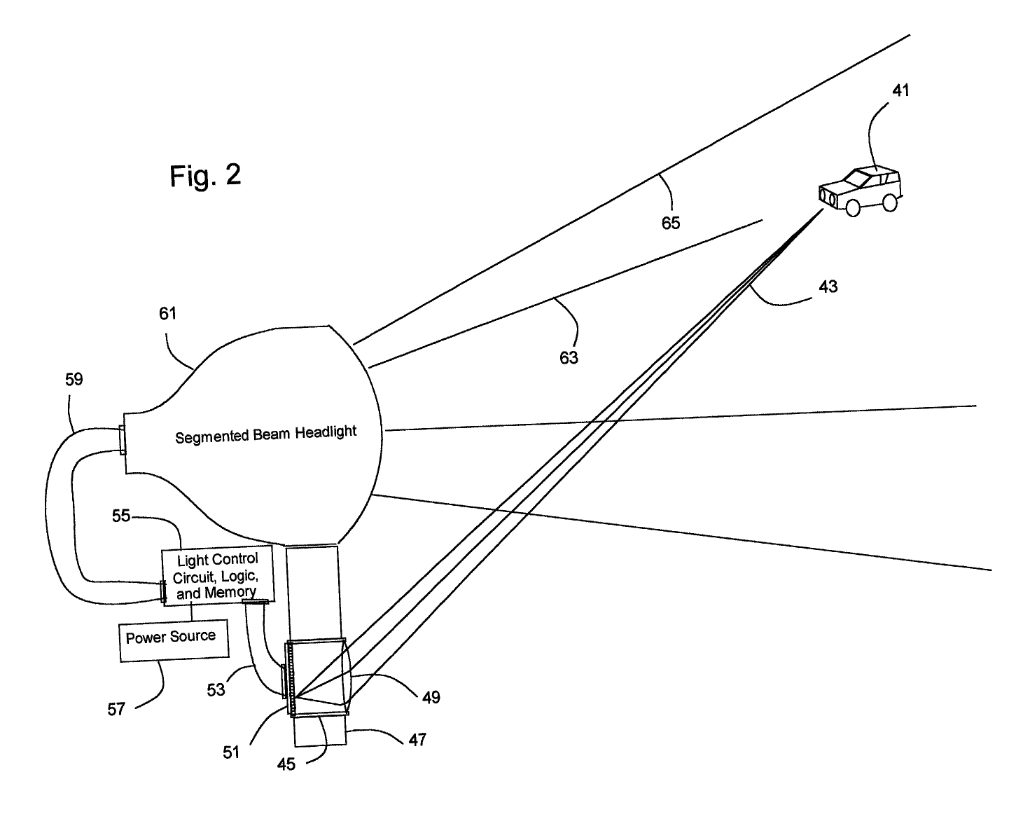

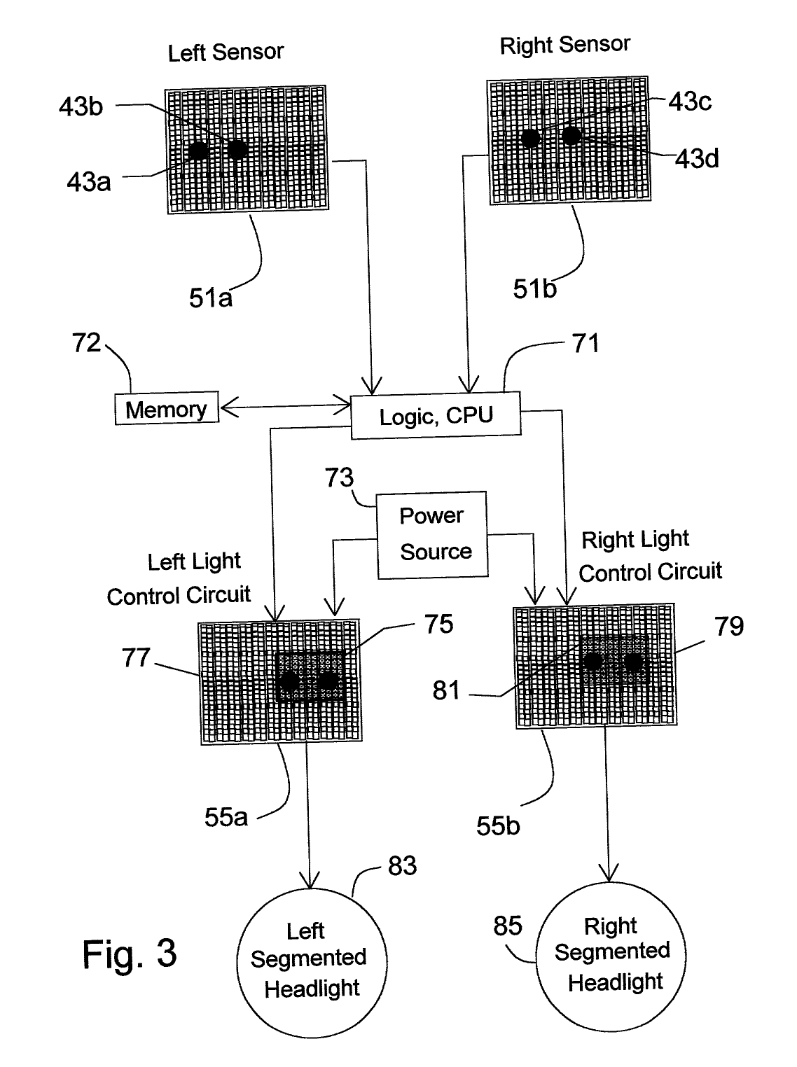

FIG. 2 illustrates the elements of a segmented distribution illumination process. A light emitting vehicle 41 emits an emitted light 43 which passes through a primary lens 49 therefore converging. The 43 falling upon one or more sectors (a function of the location of its source relative to the 49) within a detector array 51 where it is detected. The 51 is a photodiode array (or an alternate means of detecting photon intensity such as a CCD). The 49 and 51 being elements of a sensor unit 45 which is mounted on an equipped automobile 47 (47 being a part of the automobile—the fill automobile is not shown). The 51 converting photons to electrons which are sent by a ribbon cable 53 into a light control circuit including logic and memory 55. 55 is further described in FIG. 3. 55 controls which segments of a segmented beam headlight 61 are on low and which are on high by controlling the power flow to each respective sector from a power source 57. Power to the 61 going to the respective segments by passing through a segmented power cable 59. Some methods employed within 61 to segment light into independently controlled sectors are discussed later. 61 produces a high beam in a first sector 65 while concurrently producing a low beam in a second respective sector 63 (or dim beam) where the 41 is sensed. 61 also being mounted on 47. Thus the driver of 47 can see everything illuminated to the maximum except the area where 41 is. Meanwhile, the driver of 41 sees only a dim or low beam light from 47. Thus the light for both drivers is concurrently optimized by segmented the light distribution into independently controlled sectors.

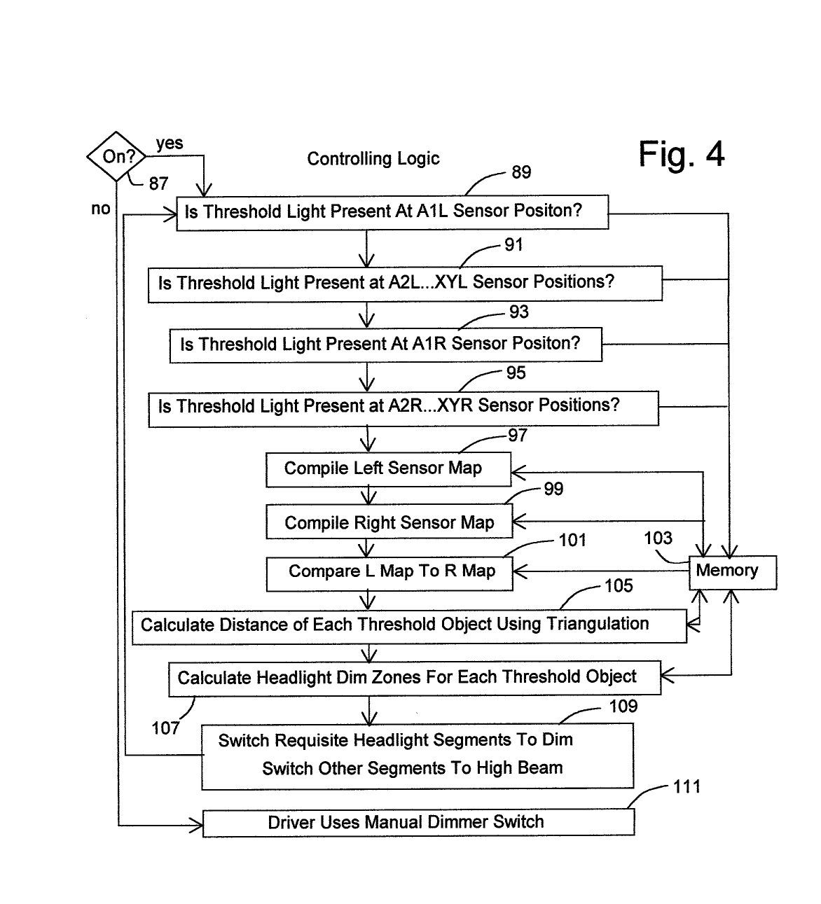

FIG. 3 is a more detailed illustration of the information flow, processes and architecture of the elements described in FIG. 2. In practice, a left sensor 51a and a right sensor 51b are used concurrently. The 51a detects the two headlights of 41 at a first illuminated spot 43a and a second illuminated spot 43b respectively. These spots of light fall upon a photon detector array which otherwise doesn't receive significant light (in this illustration). Electrons corresponding to the position and intensity of light are categorized by a logic and CPU 71 and stored in a memory 72. Meanwhile, 51b also detects the two headlights of 41 as a first spot 43c and a second spot 43d respectively. This information too is stored in memory as previously described and further detailed in FIG. 4. The right sensor and the left sensor will receive spots of nearly identical intensity and size representative of the 41 headlights but the positions on the 51a will be different relative to 51b. The less the difference between these relative positions, the greater the distance 41 is from 47. Triangulation is thus used by the CPU to determine the distance which 41 is from 47. This distance information is used to determine the intensity of light that will be produced by the 61 in the corresponding headlight sectors. Information from the 72 and 71 is sent to control the power flow from a power source 73 via a left light control circuit 55a and a right light control circuit 55b. Note that a left shaded circuit area 75 indicates the areas of a segmented headlight control switch array switches which will cause portions of the left headlight to be dim while a non-shaded left circuit area 77 represents the portions of the segmented headlight which will be on high beam. The 75 area is significantly larger than the headlight dots that were initially received by 51a and 51b because, the CPU has made assumptions about the space that may potentially be occupied by the driver of the sensed vehicle. The CPU logic flow is described in FIG. 4. Likewise, a right shaded circuit area 81 indicates the areas of a segmented headlight control switch array switches which will cause portions of the right headlight to be dim while a non-shaded right circuit area 79 represents the portions of the right segmented headlight which will be on high beam. The 81 area is significantly larger than the headlight dots that were initially received by 51a and 51b because, the CPU has made assumptions about the space that may potentially be occupied by the driver of the sensed vehicle. (The shaded areas of 55a and 55b are for illustrative purposes, in practice one can not look at a switch array matrix and tell which areas are in which state.) The 55a controls the power flow from 73 to a left segmented headlight 83 which distributes high beams throughout its distribution areas except in a box in the direction of the 41. Similarly, the 55b controls the power flow from 73 to a right segmented headlight 83 which distributes high beams throughout its distribution areas except in a box in the direction of the 41. Thus the driver of 41 has minimum glare while the driver of 47 has maximum light.

FIG. 4 illustrates a flow chart describing logic of the process described in FIG. 3. A user controlled switch 87 gives the user the ability to select whether the system is in auto mode (on) or manual mode (off). If the system is off, the user controls the headlights via a manual dimmer switch 111. When the system is on and the headlights are on, the CPU checks the status of each respective sector 89 of the light sensors. In a process to check the left sensor 89, the first sector being A1L, the amount of light received by A1L is stored in a memory 103. Likewise, the amount of light received by each sector of the left sensor sectors A2L through XYL is stored in memory in a left iterative process 91. Similarly, the status of the right sensor is stored in memory beginning with the A1L sector process of the right sensor 93. A second iterative process 95 stores information describing the amount of light received by each of the right sensor sectors A2R through XYR. Thus a left map of sensed light is stored 97 in memory and a right map of sensed light is stored in memory 99. The CPU compares the right map to the left map to determine the distance and intensity of each object sensed in a calculating process 101. A triangulation process 105 is used to determine distance of each object. The location of objects is used to calculate which zones of each headlight need to be dimmed in a calculate headlight dim zones process 107. Signals are sent to each of the headlight control circuit zones that need to be dimmed to restrict the amount of current to the corresponding headlight zones such that they are dimmed in a dimming process 109. Zones which are not dimmed remain on high beam. Thus (assuming the sensed light is above a threshold intensity or distance) the light sent to the sensed vehicle location is dimmer than the light sent to all other areas of the headlight distribution area. The process then begins again so as to be responsive to changing environmental conditions in real time.

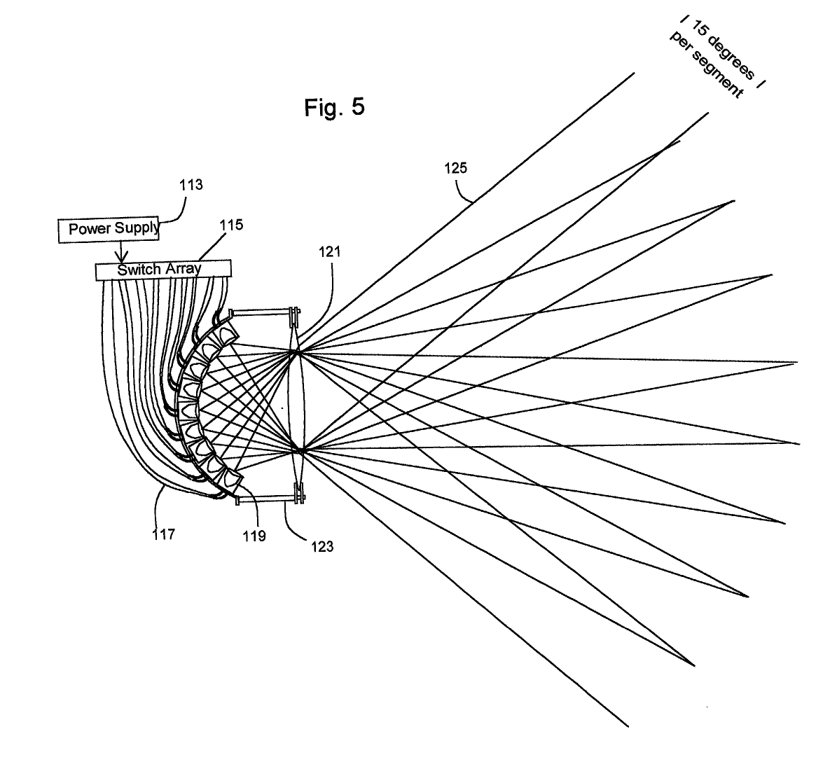

FIG. 5 illustrates the segmented headlight means and controlling switch array in a first embodiment. The head light is comprised of an array of individual lighting elements similar to light element 119. The light elements being part of a segmented head light 123. The 119 can be a white LED (or alternate lighting mechanism). Each lighting element being independently controlled by a corresponding switch in an array of switches 115. Each switch is controlled by the CPU and logic previously described. For example the power to 119 is controlled by the CPU which dictates its respective switch characteristics at 115 such that the power from a power supply 113 carried via segment wire 117 is controlled in response to the sensed environmental conditions. All of the other light elements are similarly individually controlled. The 119 and other lighting elements are on a curve along the focal point of a headlight lens 121 such that the light from each lighting element goes into a specified portion (or portions) of the headlight distribution area. Element emitted light 125 being an example of an element's light being directed into one sector of the light distribution area. In the illustration, the 125 from 119 falls across a 15 degree section of the headlight distribution area. Each other lighting element similarly falls within a defined area of the light distribution area. Thus the light sent to the area of 41 is dimmed using a headlight with segmented lighting means.

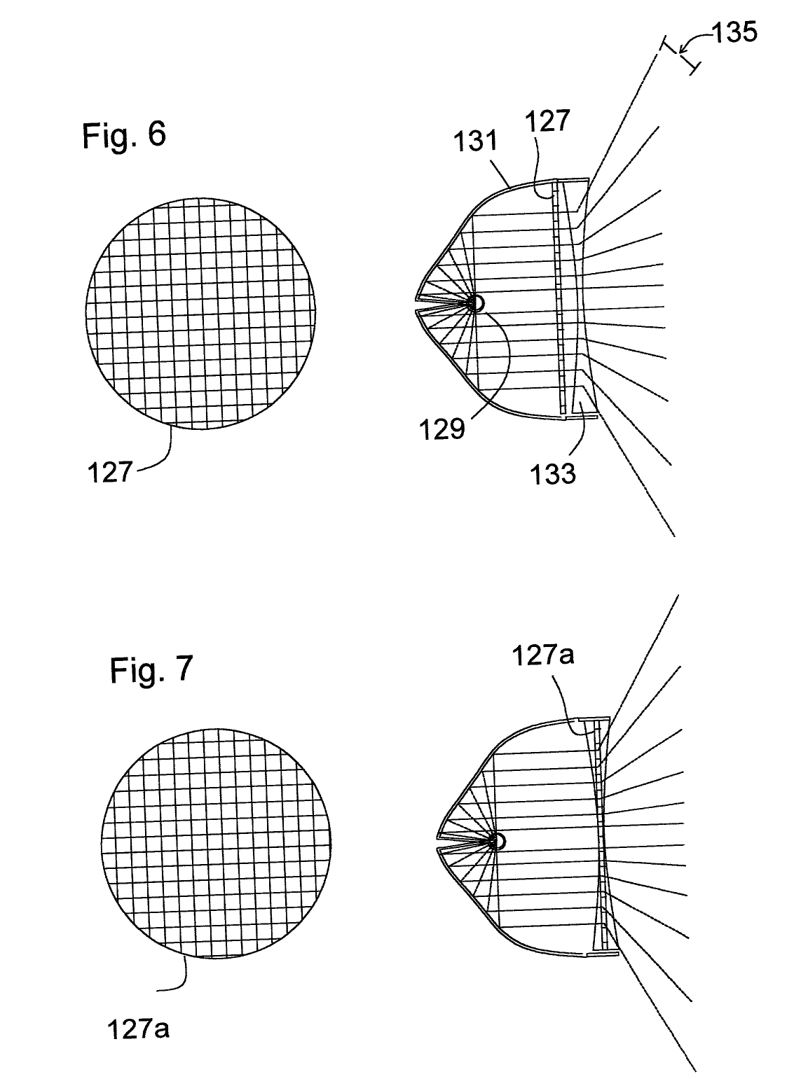

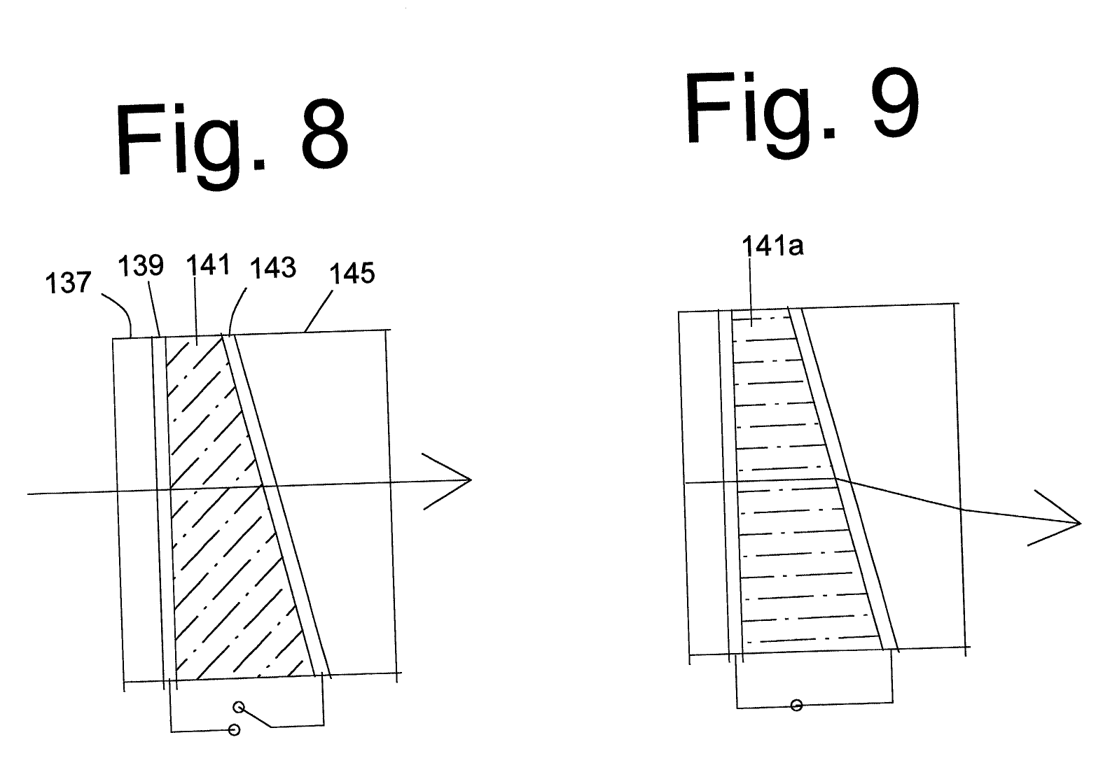

FIG. 6 illustrates headlight distribution area segmenting means of a second embodiment. A headlight with electro-chromatic dimming means 131 consists of a light element 129 which emits light which is reflected off a collimating surface resulting in collimated light. The collimated light passes through a segmented array 127 of electro chromatic cells. Using a switch array similar to 115 and the processes previously described herein, the light intensity flowing through each individual segment is controlled by causing each individual electro-chromatic cell to filter out the desired amount of light such that the distribution of light is dim where a car is sensed and on high beam elsewhere. The 127 consisting of an array of electro-chromatic cells individually controlled and individually operated according to principles known in the prior art (U.S. Pat. No. 6,248,263 Tonar et al being one such prior art example). After the light from 129 passes through a respective electric-chromatic filter segment, it is directed by a headlight optic 135 such that it travels to a specific sector of the headlight distribution area. Sample light sector 135 being one such example. Using individually controlled electro-chromatic cells in array (as further illustrated in FIG. 8 is a means of selectively controlling which areas of a headlight distribution will receive high beam and which will receive low beam. Means for sensing and controlling electrical flow to (controlling) the electro-chromatic filter array having been previously discussed and not restated to avoid redundancy.

FIG. 7 is identical to FIG. 6 except that the alternate segmented electro-chromatic element 127a is incorporated into the optic (whereas they were separate components in FIG. 6).

FIG. 8 illustrates the elements of an individual electro-optic cell in a first state. A first transparent substrate such as glass 137 has deposited on it a first transparent electrode 139. A second transparent substrate 145 such as glass has a second transparent electrode 143 deposited thereon. In the embodiment of FIG. 6 and FIG. 7, the electro-optic material 141 is an electro-chromatic material which allows greater light to pass through it in a first state (such as when the circuit is open) and a lesser amount of light to pass through when in a second state (such as when the circuit is closed.) The elements of FIG. 8 comprising an individually controlled segment of 127 or 127a segmented electro-chromatic array. In the electro-chromatic embodiment, generally the 143 surfaces are parallel to 139 surfaces (though not depicted as such in FIG. 8).

In a third embodiment, the electro-optic material 141 of FIG. 8 is a liquid crystal. The alignment of the liquid crystal causes a first refractive index in a first state when the circuit is open. This causes the light to pass straight through the elements of FIG. 8. Realigned liquid crystal 141a assumes a second state of alignment when the circuit is closed as illustrated in FIG. 9 causing the light to bend due to refraction after passing there through. The liquid crystal birefringent principals are well known in the prior art. The surfaces of 139 generally not being parallel to the 143 surfaces.

FIG. 9 is an electro-optic material of FIG. 8 in a second state of alignment.

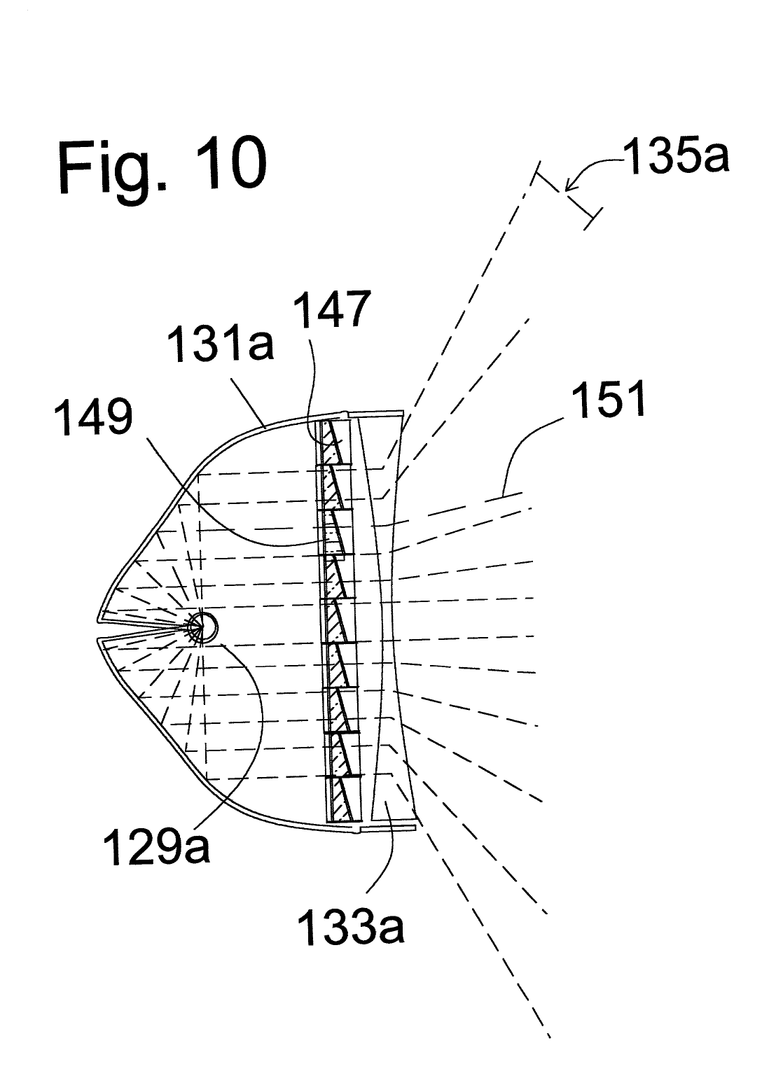

FIG. 10 depicts a segmented headlight with individually controlled sectors of distribution of the third embodiment. A single light element 129a produces collimated light due to collimating surface 131a. The light then passes through an array of variable refraction elements (described in FIG. 9). This headlight architecture enables light from an individual headlight distribution sector to be redirected in response to sensed environmental conditions when used in conjunction with the elements and processes previously discussed herein. Thus light from one section has been diverted to become diverted light 151 (in low beam where a vehicle (not shown) has been sensed) while the light from other segments are not diverted (are in high beam) where no vehicle is sensed.

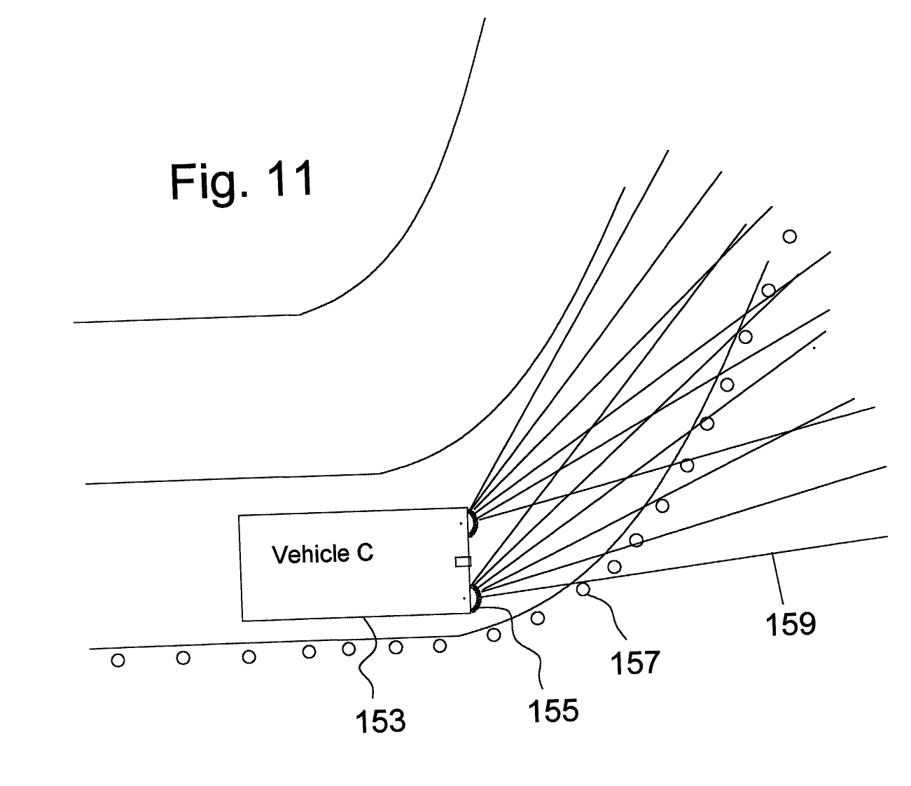

FIG. 11 illustrates the art of the present invention being used to concentrate light to look around corners in response to road conditions. An equipped vehicle 153 senses that the road turns by receiving light from reflectors such as a reflector 157. The responding headlights 155 direct light into the corner to maximize the driver's ability to see there. The directing of light can be achieved with the segmented sensing elements and segmented light distribution elements described herein.

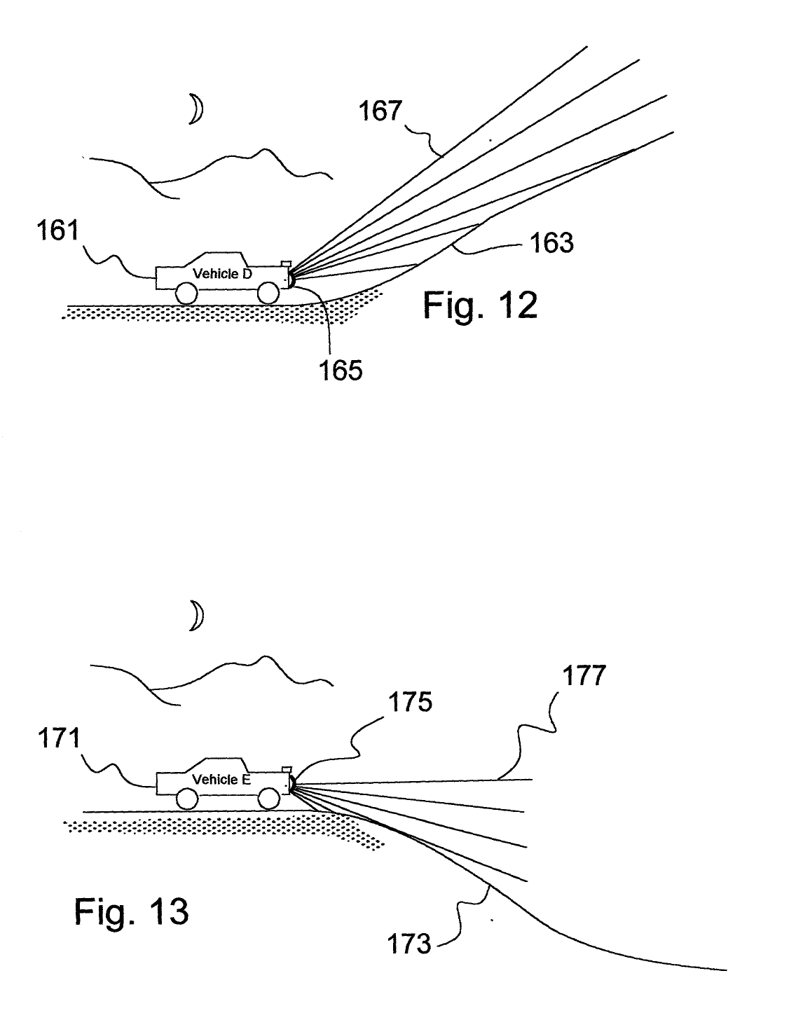

FIG. 12 illustrates the art of the present invention being used to concentrate light to look up a hill in response to road conditions. An equipped vehicle 161 senses that the road goes up a hill 163. The responding headlights 165 direct light up the hill to maximize the driver's ability to see there. The directing of light can be achieved with the segmented sensing elements and segmented light distribution elements described herein.

FIG. 13 illustrates the art of the present invention being used to concentrate light to look down a hill in response to road conditions. An equipped vehicle 171 senses that the road goes down an incline 173. The responding headlights 175 direct light down the hill to maximize the driver's ability to see there. The directing of light can be achieved with the segmented sensing elements and segmented light distribution elements described herein.

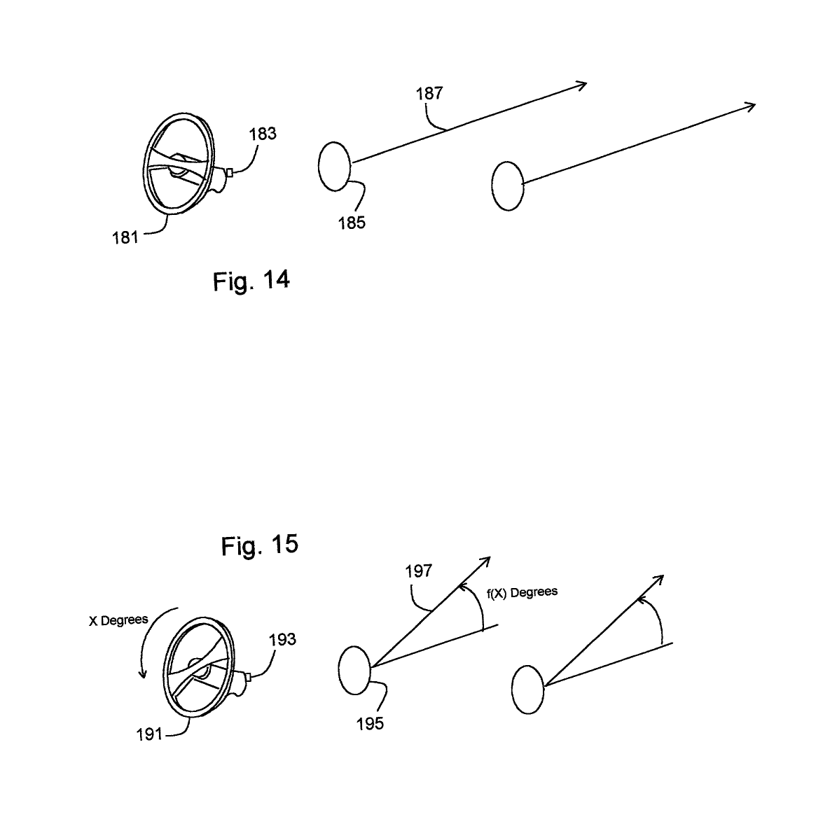

FIG. 14 illustrates the segmented distribution light of the present invention integrated interactively with the position of a steering wheel.

FIG. 15 is the steering wheel of FIG. 14 in a new position. As the steering wheel 191 rotates “x” degrees, rotation sensor 193 detects the rotation. The system calculates the new direction of the vehicle and changes the direction of the headlight output 197 a corresponding “f(x)” degrees.

Operation of the Invention

FIG. 1 depicts a vehicle employing an automatic segmented illumination means of the present invention. A first vehicle 31 emits a low beam illumination 35 in a first headlight distribution sector while concurrently emitting a high beam illumination 37 in a second headlight distribution sector. The low beam illumination in 35 being emitted in response to the detection of an oncoming vehicle 33 (the 33 emitting light which has been omitted for drawing clarity). The 31 comprising a means to detect the sector in which 33 (or any other vehicle) is located, the 31 also comprising a means to provide a first intensity of illumination in the sector where the 33 is detected while concurrently providing a second intensity (or alternate direction) of illumination where no vehicle is detected. Specific means for sensing locations of vehicles and independent sector illumination control within the light distribution area will be discussed later.

FIG. 2 illustrates the elements of a segmented distribution illumination process. A light emitting vehicle 41 emits an emitted light 43 which passes through a primary lens 49 therefore converging. The 43 falling upon one or more sectors (a function of the location of its source relative to the 49) within a detector array 51 is detected. The 51 is a photodiode array (or an alternate means of detecting photon intensity such as a CCD). The 49 and 51 being elements of a sensor unit 45 which is mounted on an equipped automobile 47 (47 being a part of the automobile—the full automobile is not shown). The 51 converting photons to electrons which are sent by a ribbon cable 53 into a light control circuit including logic and memory 55. 55 is further described in FIG. 3. 55 controls which segments of a segmented beam headlight 61 are on low and which are on high by controlling the power flow to each respective sector from a power source 57. Power to the 61 going to the respective segments by passing through a power cable 59. Some methods employed within 61 to segment light into sectors is discussed later. 61 produces a high beam in a first sector 65 while concurrently producing a low beam in a second respective sector 63 (or dim beam) where the 41 is sensed. 61 also being mounted on 47. Thus the driver of 47 can see everything illuminated to the maximum except the area where 41 is. Meanwhile, the driver of 41 sees only a dim or low beam light from 47.

FIG. 3 is a more detailed illustration of the information flow, processes and architecture of the elements described in FIG. 2. In practice, a left sensor 51a and a right sensor 51b are used concurrently. The 51a detects the two headlights of 41 at a first illuminated spot 43a and a second illuminated spot 43b. These spots of light fall upon a photon detector which otherwise doesn't receive significant light (in this illustration). Electrons corresponding to the position and intensity of light are categorized by a logic and CPU 71 and stored in a memory 72. Meanwhile, 51b also detects the two headlights of 41 as a first spot 43c and a second spot 43d respectively. This information too is stored in memory as previously described. The right sensor and the left sensor will receive spots of nearly identical intensity and size representative of the 41 headlights but the positions on the 51a will be different relative to 51b.

The less the difference between these relative positions, the greater the distance 41 is from 47. Triangulation is thus used by the CPU to determine the distance which 41 is from 47. This distance information is used to determine the intensity of light that will be produced by the 61 in the corresponding headlight sectors. Information from the 72 and 71 is sent to control the power flow from a power source 73 via a left light control circuit 55a and a right light control circuit 55b. Note that a left shaded circuit area 75 indicates the areas of a segmented headlight control switch array switches which will cause portions of the left headlight to be dim while a non-shaded left circuit area 77 represents the portions of the segmented headlight which will be on high beam. The 75 area is significantly larger than the headlight dots that were initially received by 51a and 51b because, the CPU has made assumptions about the space that may potentially be occupied by the driver of the sensed vehicle. The CPU logic flow is described in FIG. 4. Likewise, a right shaded circuit area 81 indicates the areas of a segmented headlight control switch array switches which will cause portions of the right headlight to be dim while a non-shaded right circuit area 79 represents the portions of the right segmented headlight which will be on high beam. The 81 area is significantly larger than the headlight dots that were initially received by 51a and 51b because, the CPU has made assumptions about the space that may potentially be occupied by the driver of the sensed vehicle. (The shaded areas of 55a and 55b are for illustrative purposes, in practice one cannot look at a switch array matrix and tell which areas are in which state.) The 55a controls the power flow from 73 to a left segmented headlight 83 which distributes high beams throughout its distribution areas except in a box in the direction of the 41. Similarly, the 55b controls the power flow from 73 to a right segmented headlight 83 which distributes high beams throughout its distribution areas except in a box in the direction of the 41. Thus the driver of 41 has minimum glare while the driver of 47 has maximum light.

FIG. 4 illustrates a flow chart describing logic of the process described in FIG. 3. A user controlled switch 87 gives the user the ability to select whether the system is in auto mode (on) or manual mode (off). If the system is off, the user controls the headlights via a manual dimmer switch 111. When the system is on and the headlights are on, the CPU checks the status of each respective sector 89 of the light sensors. In a process to check the left sensor 89, the first sector being A1L, the amount of light received by A1L is stored in a memory 103. Likewise, the amount of light received by each sector of the left sensor sectors A2L through XYL is stored in memory in a left iterative process 91. Similarly, the status of the right sensor is stored in memory beginning with the A1L sector process of the right sensor 93. A second iterative process 95 stores information describing the amount of light received by each of the right sensor sectors A2R through XYR. Thus a left map of sensed light is stored 97 in memory and a right map of sensed light is stored in memory 99. The CPU compares the right map to the left map to determine the distance and intensity of each object sensed in a calculating process 101. A triangulation process 105 is used to determine distance of each object. The location of objects is used to calculate which zones of each headlight need to be dimmed in a calculate headlight dim zones process 107. Signals are sent to each of the headlight control circuit zones that need to be dimmed to restrict the amount of current to the corresponding headlight zones such that they are dimmed in a dimming process 109. Zones which are not dimmed remain on high beam. Thus the light sent to the sensed vehicle location is dimmer than the light sent to all other areas of the headlight distribution area. The process then begins again so as to be responsive to changing environmental conditions in real time.

FIG. 5 illustrates the segmented headlight means and controlling switch array in a first embodiment. The head light is comprised of an array of individual lighting elements similar to light element 119. The light elements being part of a segmented head light 123. The 119 can be a white LED. Each lighting element being independently controlled by a corresponding switch in an array of switches 115. Each switch is controlled by the CPU and logic previously described. For example the power to 119 is controlled by the CPU which dictates its respective switch characteristics at 115 such that the power from a power supply 113 carried via segment wire 117 is controlled in response to the sensed environmental conditions. All of the other light elements are similarly individually controlled. The 119 and other lighting elements are on a curve along the focal point of a headlight lens 121 such that the light from each lighting element goes into a specified portion (or portions) of the headlight distribution area. Element emitted light 125 being an example of an element's light being directed into one sector of the light distribution area. In the illustration, the 125 from 119 falls across a 15 degree section of the headlight distribution area. Each other lighting element similarly falls within a defined area of the light distribution area. Thus the light sent to the area of 41 is dimmed using a headlight with segmented lighting means.

FIG. 6 illustrates headlight distribution area segmenting means of a second embodiment. A headlight with electro chromatic dimming means 131 consists of a light element 129 which emits light which is reflected off a collimating surface resulting in collimated light. The collimated light passes through a segmented array 127 of electro chromatic cells. Using a switch array similar to 115 and the processes previously described herein, the light intensity flowing through each individual segment is controlled such that the distribution of light is dim where a car is sensed and on high beam elsewhere. The 127 consisting of an array of electro chromatic cells individually controlled and individually operated according to principles known in the prior art (U.S. Pat. No. 6,248,263 Tonar et al being one such prior art example). After the light from 129 passes through a respective it is directed by a headlight optic 135 such that it travels to a specific sector of the headlight distribution area. Sample light sector 135 being one such example. Using individually controlled electro chromatic cells in array is a, means of selectively controlling which areas of a headlight distribution will receive high beam and which will receive low beam. Means for controlling the same having been previously discussed and not restated to avoid redundancy.

FIG. 7 is identical to FIG. 6 except that the alternate segmented electro-chromatic element 127a is incorporated into the optic (whereas they were separate components in FIG. 6).

FIG. 8 the element of an individual electro-optic cell in a first state. A first transparent substrate such as glass 137 has deposited on it a first transparent electrode 139. A second transparent substrate 143 such as glass has a second transparent electrode 143 fabricated thereon. In the embodiment of FIG. 6 and FIG. 7, the electro-optic material 141 is an electro chromatic material which allows greater light to pass through it in a first state (such as when the circuit is open) and a lesser amount of light to pass through when in a second state (such as when the circuit is closed.) The elements of FIG. 8 comprising an individually controlled segment of 127 or 127a segmented electro-chromatic array. In the electro chromatic embodiment, generally the 143 is parallel to 139 (though not depicted as such in FIG. 8).

In a third embodiment, the electro-optic material 141 of FIG. 8 is a liquid crystal. The alignment of the liquid crystal causes a first refractive index in a first state when the circuit is open. This causes the light to pass straight through the elements of FIG. 8. Realigned liquid crystal 141 a assumes a second state of alignment when the circuit is closed as illustrated in FIG. 9 causing the light to bend due to refraction after passing there through. The liquid crystal birefringent principals are well known in the prior art.

FIG. 9 is an electro-optic material in a second state of alignment.

FIG. 10 depicts a segmented headlight with individually controlled sectors of distribution of the third embodiment. A single light element 129a produces collimated light due to collimating surface 131a. The light then passes through an array of variable refraction elements (described in FIG. 9). This headlight architecture enables light from an individual headlight distribution sector to be redirected in response to sensed environmental conditions when used in conjunction with the elements and processes previously discussed herein. Thus light from one section has been diverted to become diverted light 151.

FIG. 11 illustrates the art of the present invention being used to concentrate light to look around corners in response to road conditions. An equipped vehicle 153 senses that the road turns by receiving light from reflectors such as a reflector 157. The responding headlights 155 direct light into the corner to maximize the driver's ability to see there. The directing of light can be achieved with the segmented elements described herein.

FIG. 12 illustrates the art of the present invention being used to concentrate light to look up a hill in response to road conditions. An equipped vehicle 161 senses that the road goes up a hill 163. The responding headlights 165 direct light up the hill to maximize the driver's ability to see there. The directing of light can be achieved with the segmented elements described herein.

FIG. 13 illustrates the art of the present invention being used to concentrate light to look down a hill in response to road conditions. An equipped vehicle 171 senses that the road goes down an incline 173. The responding headlights 175 direct light down the hill to maximize the driver's ability to see there. The directing of light can be achieved with the segmented elements described herein.

FIG. 14 illustrates the segmented distribution light of the present invention integrated with the position of a steering wheel.

FIG. 15 is the steering wheel of FIG. 14 in a new position. As the steering wheel 191 rotates x degrees, rotation sensor 193 detects the rotation. The system calculates the new direction of the vehicle and changes the direction of the headlight output 197 a corresponding f(x) degrees.

Conclusion, Ramifications, and Scope

Thus the reader will see that the segmented distribution headlight with individually controlled segments of the present invention provides a novel unanticipated, highly functional and reliable means for providing maximum light for an equipped vehicle's driver while concurrently minimizing glare experienced by drivers of other vehicles.

While the above description describes many specifications, these should not be construed as limitations on the scope of the invention, but rather as an exemplification of a preferred embodiment thereof. Many other variations are possible. For example, light sectors may overlap such that one light distribution sector is covered by more than one illumination emitting, filtering, and/or diverting sectors. One or more methods employed herein may be used in combination to vary illumination in a segmented system. Many light detector (wherein electromagnetic radiation is converted to an electric signal) techniques can be used herein as sensors, for example, photodiode, CCD etc. The segmented distribution light can be used for many applications other than motor vehicles. For example it can be used to shine light only where needed to conserve electricity when used in conjunction with a motion sensor. It will be understood that the present invention can also be used to operate a segmented light distribution system to provide illumination to independently controlled segments each operable within a range of intensities between the high beam and the low beam state.

What is claimed:

1. A vehicular headlight system producing a light distribution area, comprising
a means for sensing the location of other vehicles,
a means for diminishing the amount of light directed to said other vehicles, wherein
light directed to areas within the light distribution area not containing said other vehicles is not diminished.

2. The headlight system of claim 1 wherein said means for sensing receives photons which are converted to electrical signals.

3. The headlight system of claim 1 wherein said vehicular headlight system comprises at least one head light which contains at least two lighting elements each of said elements being individually controllable with regard to light intensity emitted there from.

4. The headlight system of claim 1 wherein said vehicular headlight system comprises at least one head light which contains at least two light filter elements, each of said elements being individually controllable with regard to controlling the intensity of light permitted to pass there through.

5. The headlight system of claim 1 wherein said vehicular headlight system comprises at least one head light which contains at least two light directing elements, each of said elements being individually controllable with regard to the output direction of light permitted to pass there through.

6. A vehicular headlight apparatus on a first vehicle, comprising,
a means for sensing the presence of a second vehicle,
a means for determining the location of said second vehicle,
a means for diminishing the amount of light directed to said second vehicle, while
concurrently not diminishing the amount of light directed from said headlight apparatus to areas not
occupied by said second vehicle.

7. The headlight apparatus of claim 6 wherein said means for sensing receives photons which are converted to electrical signals.

8. The headlight apparatus of claim 6 wherein said vehicular headlight apparatus comprises at least one headlight which contains at least two lighting elements each of said elements being individually controllable with regard to light intensity emitted there from.

9. The headlight apparatus of claim 6 wherein said vehicular headlight apparatus comprises at least one head light which contains at least two light filter elements, each of said elements being individually controllable with regard to controlling the intensity of light permitted to pass there through.

10. The headlight apparatus of claim 6 wherein said vehicular headlight apparatus comprises at least one head light which contains at least two light directing elements, each of said elements being individually controllable with regard to the output direction of light permitted to pass there through.

11. An illumination process, comprising
a means for sensing the location of vehicles,
a means for diminishing the amount of light directed to said vehicles, wherein
light directed to at least one area not containing said other vehicles is not diminished.

12. The illumination process of claim 11 wherein said means for sensing receives photons which are converted to electrical signals.

13. The illumination process of claim 11 wherein said illumination process comprises at least one headlight which contains at least two lighting elements each of said elements being individually controllable with regard to light intensity emitted there from.

14. The illumination process of claim 11 wherein said illumination process comprises at least one head light which contains at least two light filter elements, each of said elements being individually controllable with regard to controlling the intensity of light permitted to pass there through.

15. The illumination process of claim 11 wherein said illumination process comprises at least one head light which contains at least two light directing elements, each of said elements being individually controllable with regard to the output direction of light permitted to pass there through.

16. A vehicular headlight system, wherein
said system's light distribution area is segmented into at least two segments,
wherein the intensity of light directed to each said segment is independently controlled.

17. The headlight system of claim 16 wherein said means for sensing receives photons which are converted to electrical signals.

18. The headlight system of claim 16 wherein said vehicular headlight system comprises at least one head light which contains at least two lighting elements each of said elements being individually controllable with regard to light intensity emitted there from.

19. The headlight system of claim 16 wherein said vehicular headlight system comprises at least one head light which contains at least two light filter elements, each of said elements being individually controllable with regard to controlling the intensity of light permitted to pass there through.

20. The headlight system of claim 16 wherein said vehicular headlight system comprises at least one head light which contains at least two light directing elements, each of said elements being individually controllable with regard to the output direction of light permitted to pass there through.
